(19) United States
(12) Patent Application Publication
(10) Pub. No.: US 2015/0152905 A1
(43) Pub. Date: Jun. 4, 2015

(54) FITTED HOUSING

(71) Applicant: DENSO CORPORATION, Kariya-city (JP)

(72) Inventors: Yuya OHARA, Kariya-city (JP); Koichi FUJIHARA, Obu-city (JP)

(21) Appl. No.: 14/556,467

(22) Filed: Dec. 1, 2014

(30) Foreign Application Priority Data
Dec. 2, 2013 (JP) 2013-249142

(51) Int. Cl. F16B 21/06

(52) U.S. Cl. CPC F16B 21/06

(57) ABSTRACT

A fitted housing includes a first housing and a second housing. The first housing includes a rib projecting from its one surface. The rib includes a flat contact surface on one side surface of the rib, and includes a snap piece that generates elastic force in a direction perpendicular to the contact surface and a movable region that accommodates the snap piece, which is contracted, on the other side surface of the rib. The second housing is fitted to the first housing and includes a rail having an inside distance corresponding to a distance between a vertex of the contracted snap piece and the contact surface. The rib and the snap piece are fitted to the rail. A fitted portion between the first housing and the second housing is welded.

### CROSS REFERENCE TO RELATED APPLICATION

This application is based on Japanese Patent Application No. 2013-249142 filed on Dec. 2, 2013, the disclosure of which is incorporated herein by reference.

### TECHNICAL FIELD The present disclosure relates to a fitted housing including a self-pressing mechanism as a fitted part.

### BACKGROUND

There have been proposed many techniques whereby to integrate two housings made from thermoplastic resin by welding them together. One of these techniques described in, for example, JP-A-2008-207358 is a welding method whereby a self-pressing retention mechanism is provided so that laser welding can be performed without fixing a welding part beforehand by an external pressing mechanism, and a container can be sealed quickly and stably for even a relatively thick member.

The technique described in JP-A-2008-207358 is a method of welding together a member A with a layer (a) made from thermoplastic resin exposed on at least a part of its outer surface, and a member B with a layer (b) made from thermoplastic resin exposed at least on its inner surface. At a portion where the layer (a) and the layer (b) should be welded together, there is formed the self-pressing retention mechanism that presses the member A and the member B on each other and can hold the pressing state. The member A and the member B are welded together by irradiating the pressure-bonded portion with a laser beam with the layer (a) and the layer (b) pressure-bonded to each other.

However, the above-described conventional technology has issues of inhibition of smooth fitting between the container and a cover by the self-pressing mechanism, damage of the self-pressing mechanism itself or a contact region of the container or the cover with the self-pressing mechanism at the time of fitting, and self-pressing force not applied in case of the large melting amount of resin at the time of laser welding.

### SUMMARY

The present disclosure addresses at least one of the above issues. Thus, it is an objective of the present disclosure to provide a fitted housing that has a self-pressing mechanism as a fitted part, and can facilitate press-fitting and be reliably welded together.

To achieve the objective of the present disclosure, there is provided a fitted housing including a first housing and a second housing. The first housing includes a rib projecting from its one surface. The rib includes a flat contact surface on one side surface of the rib, and includes a snap piece that generates elastic force in a direction perpendicular to the contact surface and a movable region that accommodates the snap piece, which is contracted, on the other side surface of the rib. The second housing is fitted to the first housing and includes a rail having an inside distance corresponding to a distance between a vertex of the contracted snap piece and the contact surface. The rib and the snap piece are fitted to the rail. A fitted portion between the first housing and the second housing is welded.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a perspective view illustrating a collision detection sensor of the present disclosure during press-fitting;

FIG. 2 is a sectional view illustrating a first housing, a rib, a snap piece, and a movable region in accordance with a first embodiment;

FIG. 3 is a sectional view illustrating a state where the rib and the snap piece in FIG. 2 are press-fitted between rails of a second housing;

FIG. 4 is a sectional view illustrating that the parts in FIG. 3 are welded together to provide a fitted housing of the present disclosure;

FIG. 5 is a sectional view illustrating a first housing, a rib, a snap piece, and a movable region in accordance with a second embodiment;

FIG. 6 is a sectional view illustrating a state where the rib and the snap piece in FIG. 5 are press-fitted between rails of a second housing;

FIG. 7 is a sectional view illustrating that the parts in FIG. 6 are welded together to provide the fitted housing of the present disclosure;

FIG. 8 is a sectional view illustrating a first housing, a rib, a snap piece, and a movable region in accordance with a third embodiment;

FIG. 9 is a sectional view illustrating a state where the rib and the snap piece in FIG. 8 are press-fitted between rails of a second housing;

FIG. 10 is a sectional view illustrating that the parts in FIG. 9 are welded together to provide the fitted housing of the present disclosure;

FIG. 11 is a sectional view illustrating a first housing, a rib, a snap piece, and a movable region in accordance with a fourth embodiment;

FIG. 12 is a sectional view illustrating a state where the rib and the snap piece in FIG. 11 are press-fitted between rails of a second housing;

FIG. 13 is a sectional view illustrating that the parts in FIG. 12 are welded together to provide the fitted housing of the present disclosure;

FIG. 14 is a sectional view illustrating a first housing, a rib, a snap piece, and a movable region in accordance with a fifth embodiment;

FIG. 15 is a sectional view illustrating a state where the rib and the snap piece in FIG. 14 are press-fitted between rails of a second housing;

FIG. 16 is a sectional view illustrating that the parts in FIG. 15 are welded together to provide the fitted housing of the present disclosure;

FIG. 17 is a graph illustrating an influence of presence or absence of the movable region for the snap piece on a relationship between a press-fit distance and a press-fit load according to the first embodiment;

FIG. 18 is a graph illustrating an influence of the presence or absence of the movable region for the snap piece on a relationship between height of the snap piece and the press-fit load according to the first embodiment; and

FIG. 19 is a diagram viewed from an arrowed line XIX in FIG. 2.

### DETAILED DESCRIPTION

Embodiments in which a fitted housing of the present disclosure is applied to a collision detection sensor will be described below with reference to the accompanying drawings. In all the drawings in the description, the same reference numeral is given to mutually corresponding parts, and later explanation of the repeated part will be omitted on a timely basis.

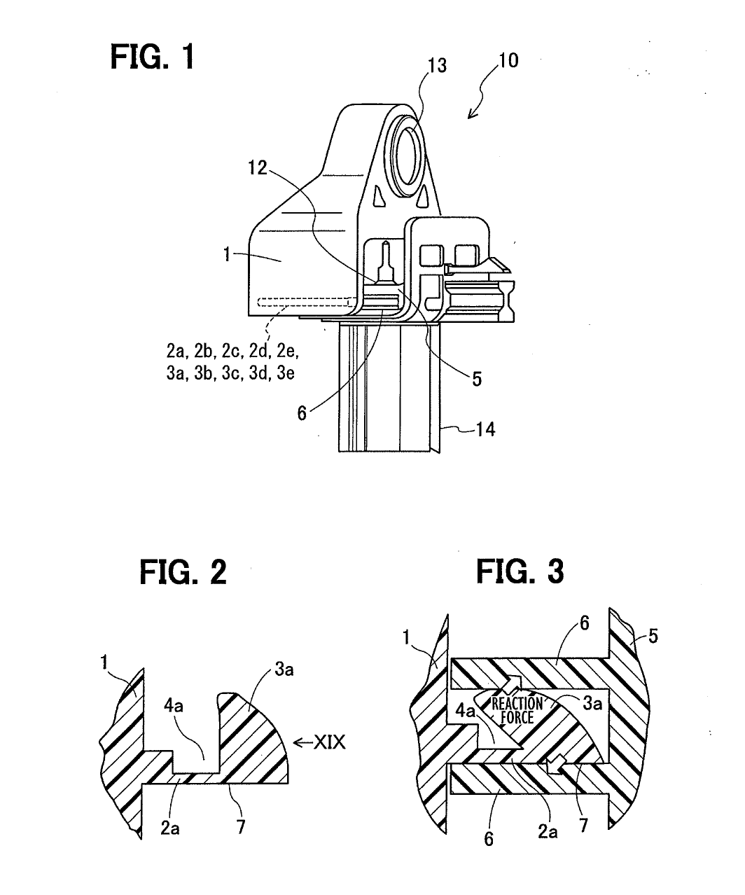

A collision detection sensor 10 (fitted housing) of the present embodiments is referred to as a satellite sensor that includes an acceleration sensor for detecting acceleration accommodated in the housing and that is disposed on a front, rear, or lateral side of a vehicle to detect an impact. As illustrated in FIG. 1, the collision detection sensor 10 includes a first housing 1 and a second housing 5.

The first housing 1 includes ribs 2a to 2e and snap pieces 3a to 3e provided on internal surfaces of both its wings, and an attachment hole 13 for attaching the collision detection sensor 10 to the vehicle. The second housing 5 includes rails 6. provided on both its lateral surfaces and fitted to the ribs 2a to 2e and the snap pieces 3a to 3e, an acceleration sensor element 12, and a connector 14 for outputting an electrical signal from the collision detection sensor 10.

### FIRST EMBODIMENT

A first embodiment will be described with reference to FIGS. 2 to 4. As illustrated in FIG. 2, the first housing 1 made from synthetic resin or the like includes the rib 2a that projects from one surface of the housing t A material of the rib 2a is thermoplastic synthetic resin. One side surface of the rib 2a is a flat contact surface 7. On the other side surface of the rib 2a, the snap piece 3a made from thermoplastic resin and having a tongue-like shape in cross-section is provided to rise up from a distal end part of the rib 2a. The snap piece 3a generates elastic force in a direction perpendicular to the contact surface 7. A movable region 4a that is adjacent to the snap piece 3a and is a U-shaped groove is formed on the other side surface of the rib 2a. The movable region 4a is a space that accommodates the snap piece 3a when the snap piece 3a is elastically displaced toward the first housing 1 and the rib 2a and is contracted in the direction perpendicular to the contact surface 7. As illustrated in FIG. 19, a tapered part 11 is formed at either one or both of ends of the snap piece 3a such that height of the vertex of the snap piece 3a from the contact surface 7 decreases gradually toward an end face of the snap piece 3a.

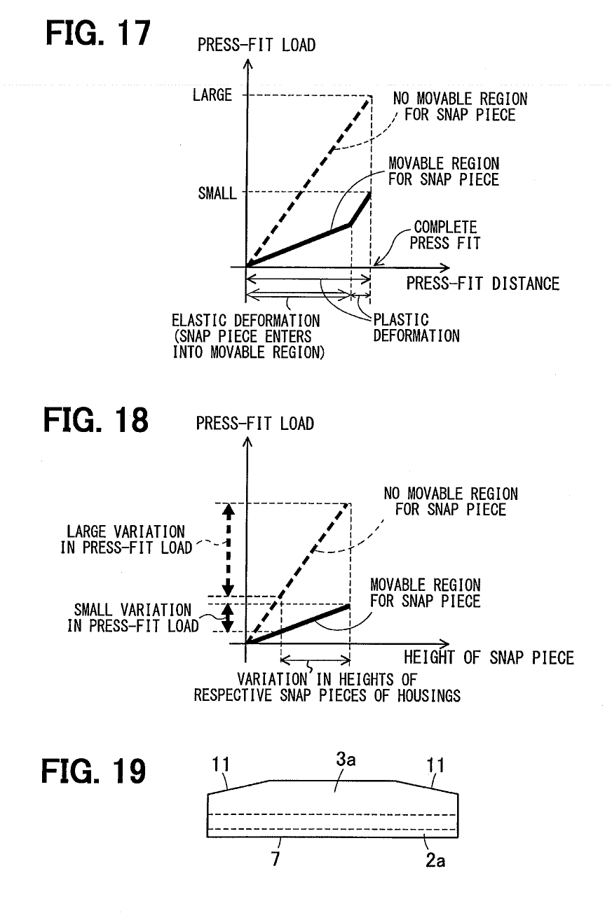

As illustrated in FIG. 3, the rib 2a and the snap piece 3a in FIG. 2 are press-fitted in a direction perpendicular to a plane of paper of FIG. 3 between rails 6, 6 that project from one surface of the second housing 5 made from synthetic resin or the like. However, although not shown, the rails may be carved on the one surface of the second housing 5. Accordingly, the first housing 1 and the second housing 5 are fitted together to be integrated. Because an inner size between the rails 6, 6 is smaller than the height of the vertex of the elastically-recovered snap piece 3a in FIG. 2 from the contact surface 7, the insertion may become difficult at the time of the start of press-fitting. In this case, the above tapered part 11 functions effectively. After that, as a distance of press-fitting becomes larger, reaction forces indicated by arrows in FIG. 3 increase. This reaction force correlates with a press-fit load, and a state of the correlation is indicated by a continuous line in FIG. 17.

In FIG. 17, for reference, there is indicated by a short dashes line a press-fit load in a case of no movable region for the snap piece, i.e., in a case where although having the snap piece, it is not movable or a case of a planar shape similar to the contact surface instead of the snap piece. In FIG. 17, it is found that the press-fit load is reduced considerably by providing the snap piece and its movable region.

As illustrated in FIG. 18, if the height of the vertex of the snap piece from the contact surface differs from one housing to another to show variation, the variation amount of the press-fit load when the housing 1 includes the movable region of the snap piece is smaller than the variation amount of the press-fit load when the housing 1 does not include the movable region of the snap piece. Accordingly, in the present embodiment, there can be broadened a permissible range of the height of the vertex of the snap piece from the contact surface which varies from one housing to another, and manufacturing control is greatly facilitated.

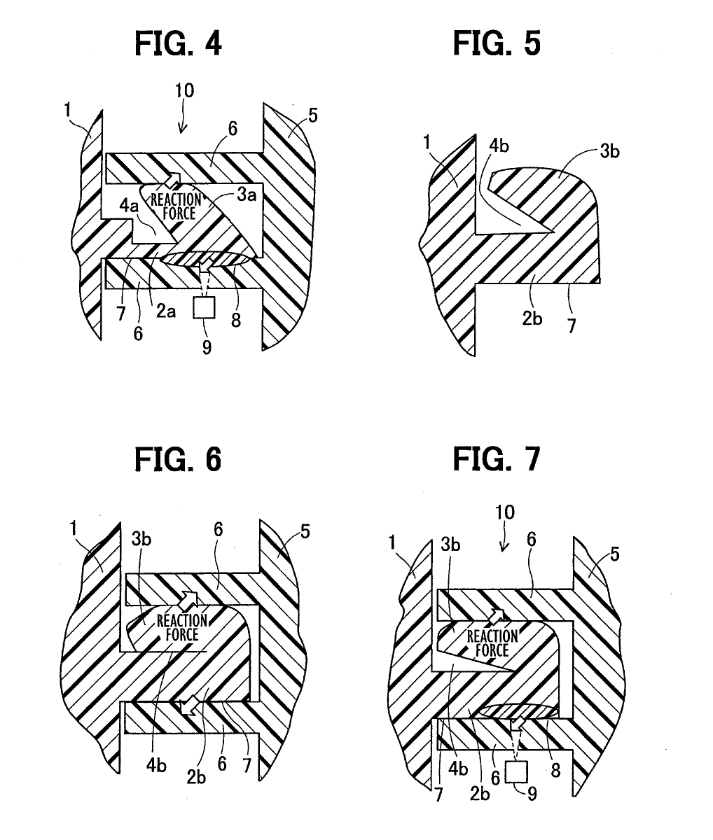

As illustrated in FIG. 4, the rib 2a and the snap piece 3a press-fitted between the rails 6, 6 are welded by a laser equipment 9 to form a welded portion 8. The welded portion 8 is formed between the contact surface 7 of the rib 2a and an inner surface of the rail 6. Alternatively, the welded portion 8 may be formed between vicinity of the vertex of the snap piece 3a and an inner surface of the rail 6 The rail 6 is shaped from a material through which easily laser light permeates, and the rib 2a or the snap piece 3a are shaped from a material with which carbon or the like is mixed to easily absorb the laser light. The laser light is concentrated into the welded portion 8, and the portion 8 is irradiated with the laser light. After the rib 2a or the snap piece 3a is melted, the rail 6 attached firmly thereto is also melted. The resin materials of both the members are melted together, and then solidified to form the welded portion 8. Accordingly, the collision detection sensor 10 as a fitted housing is produced. In addition, welding may be performed by ultrasonic waves or vibration instead of the laser light.

As a result of the welded portion 8 being melted or the fitted portion being plastically-deformed, a size of the height of the vertex of the snap piece 3a from the contact surface 7 is slightly reduced. However, because this change is set within a range of elastic deformation of the snap piece 3a, the reaction force exists as illustrated in FIG. 4 although smaller than the reaction force at the time of press-fitting. Accordingly, this reaction force serves as self-pressing retention force, and thus close attachment of the fitted portion is improved so that welding can be carried out stably and reliably without providing a pressing mechanism outside. This effect is further enhanced when the welded portion is provided between the contact surface 7 of the rib 2a and the inner surface of the rail 6 rather than between the vicinity of the vertex of the snap piece 3a and the inner surface of the rail 6.

### SECOND EMBODIMENT

A second embodiment will be described with reference to FIGS. 5 to 7. Since the matters concerning press-fitting and welding in the second embodiment and thereafter are similar to those in the first embodiment, their explanations will be omitted, and the descriptions of the second embodiment and thereafter are limited only to explanation of a rib, a snap piece, and a movable region provided for a first housing.

As illustrated in FIGS. 5 to 7, a first housing 1 made from synthetic resin or the like includes a rib 2b projecting from one surface of the first housing 1. A material of the rib 2b is thermoplastic synthetic resin. One side surface of the rib 2b is a flat contact surface 7. On the other side surface of the rib 2b, a snap piece 3b made from thermoplastic resin and having a tongue-like shape in cross-section is provided to rise up from a distal end part of the rib 2b and to be inclined toward the first housing 1. The snap piece 3b generates elastic force in a direction perpendicular to the contact surface 7. Furthermore, on the other side surface of the rib 2b, a movable region 4b of a V-shaped groove is formed between a side surface of the snap piece 3b on the rib 2b-side and the other side surface of the rib 2b. The movable region 4b is a space that accommodates the snap piece 3b to close a V-shaped opening when the snap piece 3b is elastically displaced toward the other side surface of the rib 2b and is contracted. Although not shown, a tapered part is formed at either one or both of ends of the snap piece 3b such that height of the vertex of the snap piece 3b from the contact surface 7 decreases gradually toward an end face of the snap piece 3b.

### THIRD EMBODIMENT

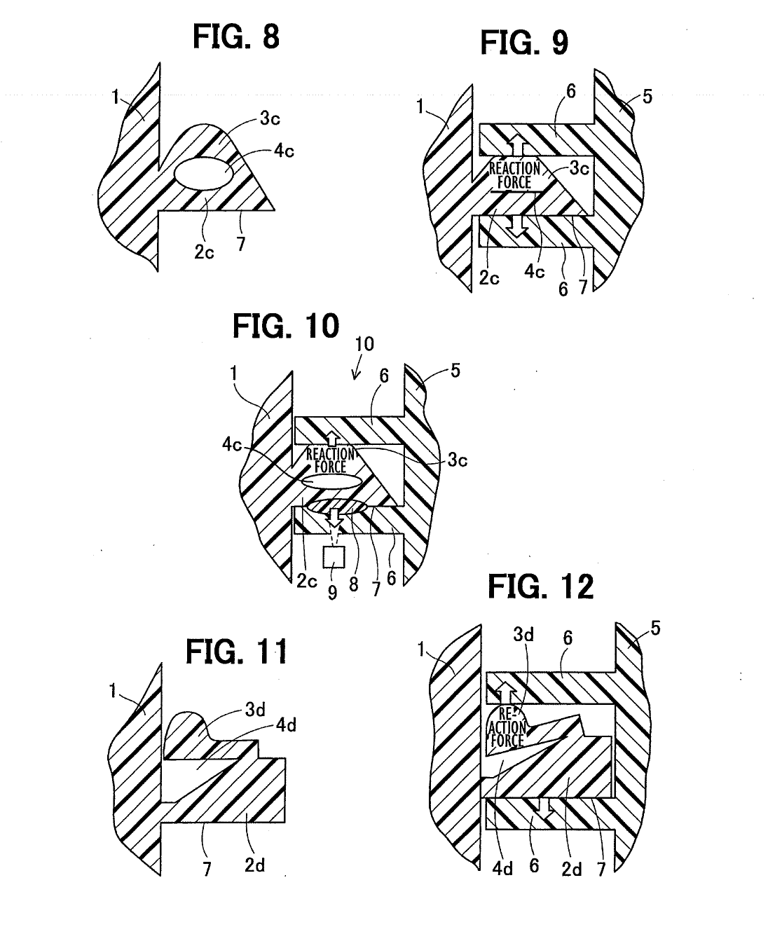

As illustrated in FIGS. 8 to 10, a first housing 1 made from synthetic resin or the like includes a rib 2c projecting from one surface of the first housing 1. A material of the rib 2c is thermoplastic synthetic resin. One side surface of the rib 2c is a flat contact surface 7. A snap piece 3c made from thermoplastic resin and having a chevron shape in cross-section is provided to rise up from the other side surface of the rib 2c. The snap piece 3c generates elastic force in a direction perpendicular to the contact surface 7. Furthermore, a movable region 4c having a tunnel shape is formed in the snap piece 3c. The movable region 4c is a space that accommodates the snap piece 3c and is thereby crushed when the snap piece 3c is pressed from its vertex toward the rib 2c and elastically displaced to be contracted. Although not shown, a tapered part is formed at either one or both of ends of the snap piece 3c such that height of the vertex of the snap piece 3c from the contact surface 7 decreases gradually toward an end face of the snap piece 3c.

### FOURTH EMBODIMENT

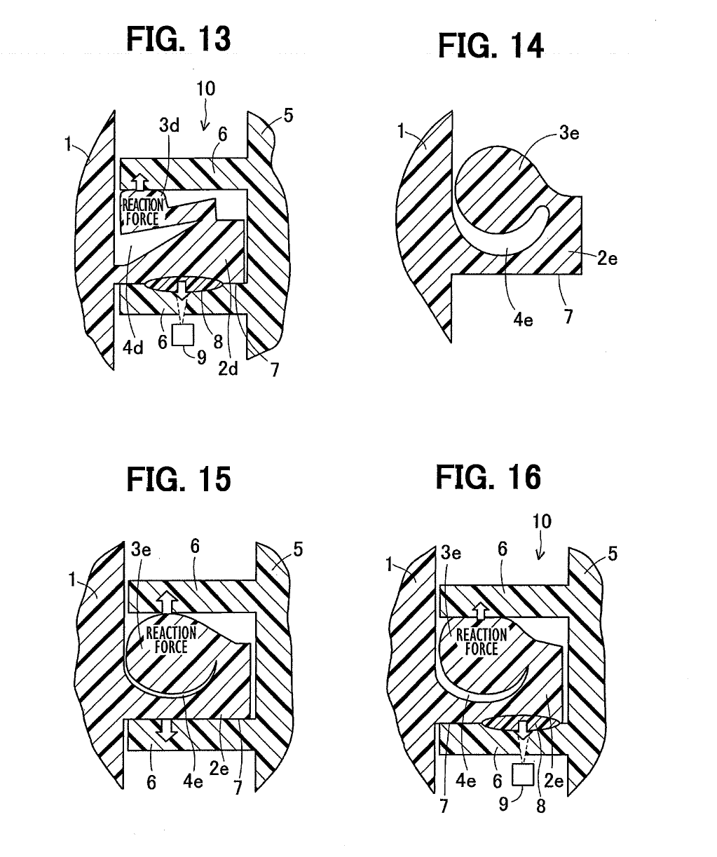

As illustrated in FIGS. 11 to 13, a first housing 1 made from synthetic resin or the like includes a rib 2d projecting from one surface of the first housing 1. A material of the rib 2d is thermoplastic synthetic resin. One side surface of the rib 2d is a flat contact surface 7. On the other side surface of the rib 2d, a snap piece 3d made from thermoplastic resin is provided to project from an intermediate position of the rib 2d near its distal end part toward the first housing 1. An opposite side of a distal end part of the snap piece 3d from the rib 2d is formed in a semicircular shape in cross-section. The snap piece 3d generates elastic force in a direction perpendicular to the contact surface 7. Furthermore, a movable region 4d of a V-shaped groove is formed between a side surface of the snap piece 3d on the rib 2d-side and the other side surface of the rib 2d. The movable region 4d is a space that accommodates the snap piece 3d to close a V-shaped opening when the snap piece 3d is pressed from its vertex toward the rib 2d and elastically displaced to be contracted. As illustrated in FIG. 12, because the vicinity of the vertex of the snap piece 3d which is a part of the snap piece 3d that is in contact with an inner surface of a rail 6 is formed in a circular arc shape in cross-section, reaction force at the time of press-fitting is in a direction perpendicular to the contact surface 7. Accordingly, force perpendicular to the press-fitting direction and the reaction force direction is not applied to the snap piece 3d, so that press-fitting can be performed more stably. Although not shown, a tapered part is formed at either one or both of ends of the snap piece 3d such that height of the vertex of the snap piece 3d from the contact surface 7 decreases gradually toward an end face of the snap piece 3d.

### FIFTH EMBODIMENT

As illustrated in FIGS. 14 to 16, a first housing 1 made from synthetic resin or the like includes a rib 2e projecting from one surface of the first housing 1. A material of the rib 2e is thermoplastic synthetic resin. One side surface of the rib 2e is a flat contact surface 7. On the other side surface of the rib 2e, a snap piece 3e made from thermoplastic resin and having a round bar shape is provided to project from vicinity of a distal end part of the rib 2e toward the first housing 1. The snap piece 3e generates elastic force in a direction perpendicular to the contact surface 7. Furthermore, a movable region 4e of a semicircular groove having the same shape as the snap piece 3e is formed between the rib 2e-side of the snap piece 3e and the other side surface of the rib 2e. The movable region 4e is a space that accommodates the snap piece 3e and is thereby crushed when the snap piece 3e is pressed from its vertex toward the rib 2e and elastically displaced to be contracted. As illustrated in FIG. 15, because the vicinity of the vertex of the snap piece 3e which is a part of the snap piece 3e that is in contact with an inner surface of a rail 6 is formed in a circular arc shape in cross-section, reaction force at the time of press-fitting is in a direction perpendicular to the contact surface 7. Accordingly, force perpendicular to the press-fitting direction and the reaction force direction is not applied to the snap piece 3e, so that press-fitting can be performed more stably. Although not shown, a tapered part is formed at either one or both of ends of the snap piece 3e such that height of the vertex of the snap piece 3e from the contact surface 7 decreases gradually toward an end face of the snap piece 3e.

As is clear from the above detailed description, the collision detection sensor 10 of the present embodiments includes the first housing 1 and the second housing 5 fitted together. The first housing 1 includes the ribs 2a to 2e that are provided to project from its one surface, and the ribs 2a to 2e include the flat contact surface 7 on their one side surface. On the other side surfaces of the ribs 2a to 2e, the first housing 1 includes the snap pieces 3a to 3e that generate the elastic force in the direction perpendicular to the contact surface 7, and the movable regions 4a to 4e that respectively accommodate the contracted snap pieces 3a to 3e. The second housing 5 includes the rails 6, 6 which have the inside distance corresponding to a distance between vertexes of the contracted snap pieces 3a to 3e and the contact surface 7 and between which the ribs 2a to 2e and the snap pieces 3a to 3e are fitted.

As a result, the first housing and the second housing can extremely easily be fitted together, and there is produced a beneficial effect of broadening the permissible range for size variation at the fitted portion between the housings. Moreover, the reaction force generated in the snap piece serves as the self-pressing retention force, so that close attachment of the engaged portion is improved and welding can be carried out stably and reliably without providing a pressing mechanism outside.

Furthermore, welding is performed between the ribs 2a to 2e and the rail 6. Accordingly, the welding can be carried out more stably and more reliably.

The snap pieces 3a to 3e include the tapered part 11 at their end. Accordingly, the snap pieces 3a to 3e and the ribs 2a to 2e can extremely easily start to be press-fitted between the rails 6, 6.

The parts of the snap pieces 3d, 3e in contact with the rail 6 have a circular arc shape in cross-section. Accordingly, the reaction force at the time of press-fitting is in a direction perpendicular to the contact surface 7. The force perpendicular to the press-fitting direction and the reaction force direction is not applied to the snap pieces 3d, 3e, so that press-fitting can be performed more stably.

In addition, the first housing and the second housing are housings of the collision detection sensor disposed in the vehicle. Accordingly, the collision detection sensor can be assembled easily and with high efficiency.

The present disclosure includes those which can be practiced in modes to which various modifications, corrections, or improvements are made based on knowledge of those skilled in the art. It is indisputable that the practiced modes, to which the above modifications are made, are all included in the scope of the invention without departing from the scope of the invention.

To sum up, the fitted housing 10 in accordance with the above embodiments can be described as follows.

A fitted housing 10 includes a first housing 1 and a second housing 5. The first housing 1 includes a rib 2a to 2e projecting from its one surface. The rib 2a to 2e includes a flat contact surface 7 on one side surface of the rib 2a to 2e, and includes a snap piece 3a to 3e that generates elastic force in a direction perpendicular to the contact surface 7 and a movable region 4a to 4e that accommodates the snap piece 3a to 3e, which is contracted, on the other side surface of the rib 2a to 2e. The second housing 5 is fitted to the first housing 1 and includes a rail 6 having an inside distance corresponding to a distance between a vertex of the contracted snap piece 3a to 3e and the contact surface 7. The rib 2a to 2e and the snap piece 3a to 3e are fitted to the rail 6. A fitted portion between the first housing 1 and the second housing 5 is welded.

Accordingly, the first housing 1 and the second housing 5 can extremely easily be fitted together, and there is produced a beneficial effect of broadening the permissible range for size variation at the fitted portion between the housings 1, 5. Moreover, the reaction force generated in the snap pieces 3a to 3e serves as the self-pressing retention force, so that close attachment of the engaged portion is improved and welding can be carried out stably and reliably without providing a pressing mechanism outside.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A fitted housing comprising:
a first housing that includes a rib projecting from its one surface, wherein the rib includes a flat contact surface on one side surface of the rib, and includes a snap piece that generates elastic force in a direction perpendicular to the contact surface and a movable region that accommodates the snap piece, which is contracted, on the other side surface of the rib; and
a second housing that is fitted to the first housing and includes a rail having an inside distance corresponding to a distance between a vertex of the contracted snap piece and the contact surface, wherein:
the rib and the snap piece are fitted to the rail; and
a fitted portion between the first housing and the second housing is welded.

2. The fitted housing according to claim 1, wherein the rib and the rail are welded together therebetween.

3. The fitted housing according to claim 1, wherein the snap piece includes a tapered part at its end portion.

4. The fitted housing according to claim 1, wherein a part of the snap piece in contact with the rail has a circular arc shape in cross-section.

5. The fitted housing according to claim 1, wherein the first housing and the second housing are housings for a collision detection sensor disposed in a vehicle.
